(19) United States
(12) Patent Application Publication
(10) Pub. No.: US 2014/0213295 A1
(43) Pub. Date: Jul. 31, 2014

(54) SYSTEMS AND METHODS FOR LOCATION-BASED GROUP TRACKING AND NOTIFICATIONS

(71) Applicant: Whoozat Inc., Chicago, IL (US)

(72) Inventor: Curt Alan Conklin, Chicago, IL (US)

(21) Appl. No.: 14/168,821

(22) Filed: Jan. 30, 2014

Related U.S. Application Data
(60) Provisional application No. 61/758,672, filed on Jan. 30, 2013.

(51) Int. Cl. H04W 4/02

(52) U.S. Cl. CPC H04W 4/02
USPC 455/456.2

(57) ABSTRACT

Systems and methods are provided for creating and associating notification groups, such as affinity groups, and assigned locations, such as associated social hubs. The locations of group members at the assigned locations are tracked and notifications to the notification group are transmitted when group members are at the assigned locations. Group creation requests, location assignment requests, and association requests are received that respectively create generic groups, assigned locations, and notification groups. Invitations can be transmitted to group members to join the notification groups. When an electronic device associated with a group member is at an assigned location, notifications that the group member is at the assigned location are transmitted to other group members. Information is also transmitted to group members when a trigger event occurs. A user can advantageously create and control both the broadcasting of the location of the user and the audience that can see that location.

### CROSS REFERENCE TO RELATED APPLICATION

This application claims the benefit of U.S. Provisional Patent Application No. 61/758,672 filed on Jan. 30, 2013, which is incorporated herein by reference.

### TECHNICAL FIELD

This invention relates to systems and methods for location-based group tracking and notifications. More particularly, the invention provides systems and methods for creating, managing, and associating notification groups and assigned locations, tracking the location of group members at the assigned locations, and transmitting or otherwise providing notifications to the notification group when group members are at the assigned locations.

### BACKGROUND OF THE INVENTION

Electronic devices, such as smartphones, tablet computers, personal digital assistants, and the like, have become more prevalent in recent years. Many of these electronic devices have the ability to determine their geographic location using geo-locator functionality, such as by utilizing a Global Positioning System (GPS) receiver, cellular tower tracking, Wi-Fi positioning, and other means. The users of such electronic devices can interact with a wide array of applications that use the geo-locator functionality, including mapping services, social networking, and other applications. Such applications have enabled the users of electronic devices to leverage their geographic locations for social networking, business purposes, safety purposes, personal purposes, and other purposes.

Typical applications enable a user to broadcast the user's location to a particular audience, such as a group or network that may include selected friends and family of the user. Some applications may enable a user to control whether his location is broadcasted but do not enable the user to control the group that can see the location. In this case, the location of the user may be broadcast to the entire group when the user actively decides to broadcast the location. For example, the user may utilize a social media application that allows “check-ins” to a business or other location, and broadcasts the user's presence at that location to the user's entire network when the user has checked-in to that location.

Other applications may enable the user to control the group that can see the location, but do not enable the user to control the broadcasting of the location to the group. In this case, the location of the user may be broadcast to the group at all times, and the user cannot easily decide when to broadcast the location. For example, the user may utilize an application that continuously broadcasts the user's location to the user's network, regardless of whether the user is at a particular location. No existing applications provide integrated control and functionality based on both the group and location concepts.

Therefore, there is a need for improved systems and methods for location-based group tracking that can enable a user to easily and conveniently create, manage, and control both the broadcasting, or notification, of the location of the user and the audience that can see the location of the user.

### SUMMARY OF THE INVENTION

The invention is intended to solve the above-noted problems by providing systems and methods for creating and managing location-based notification groups and transmitting or otherwise providing notifications to the location-based notification groups. According to a particular aspect, the systems and methods can be leveraged in a social media context to allow formation of groups based on common interests, affiliations or associations, thereby defining an affinity group, and associate the affinity group to one or more locations that may be related to the affinity group's activities, thereby defining an associated social hub.

According to a particular aspect, the systems and methods: (1) create a generic group with prospective group members based on a received group creation request; (2) create an assigned location based on a received location assignment request; (3) create a notification group that associates a generic group with an assigned location based on an association request; (4) transmit invitation requests to prospective group members of the generic group; (5) assign group members to the notification group if the invitation requests are accepted by one or more of the prospective group members; (6) determine if a geographical location of an electronic device corresponds to an assigned location associated with a notification group; and (7) transmit or otherwise communicate to group members of a notification group a notification that a locatable group member is at an assigned location associated with the notification group.

In a particular embodiment, a group creation request may be received. The group creation request may include a request to create a generic group including one or more prospective group members. The generic group including the prospective group members can be created in a database based on the group creation request. A location assignment request can be received that includes a request to create an assigned location including a geographical location. The assigned location can be created based on the location assignment request, and the assigned location can be the geographical location from the location assignment request. An association request can be received that includes a request to create a notification group associating the generic group with the assigned location. The notification group can be created in the database based on the association request. An invitation request can be transmitted to each of the prospective group members of the generic group, in response to the creation of the notification group. An acceptance of the invitation request can be received from at least one group member of the prospective group members, and the at least one group member can be assigned to the notification group in the database, in response to receiving the acceptance.

In another embodiment, a device identifier and a geographical location can be received. The device identifier can uniquely identify an electronic device associated with a locatable group member. The locatable group member can be a group member of a notification group. It can be determined whether the geographical location corresponds to an assigned location associated with the notification group in a database. If the geographical location corresponds to the assigned location, then it can be stored in the database that the locatable group member is located at the assigned location. A notification can be transmitted to each of the group members of the notification group that the locatable group member is presently located at the assigned location.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a block diagram illustrating an embodiment of a notification group tracking system.

FIG. 2 is a block diagram of one form of a computer or server of FIG. 1 having a memory element with a computer readable medium for implementing the notification group tracking system.

FIG. 3 is a flowchart illustrating operations for creating a location-based notification group using the system of FIG. 1.

FIG. 4 is a flowchart illustrating operations for generating a notification to a location-based notification group using the system of FIG. 1.

### DETAILED DESCRIPTION OF THE INVENTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

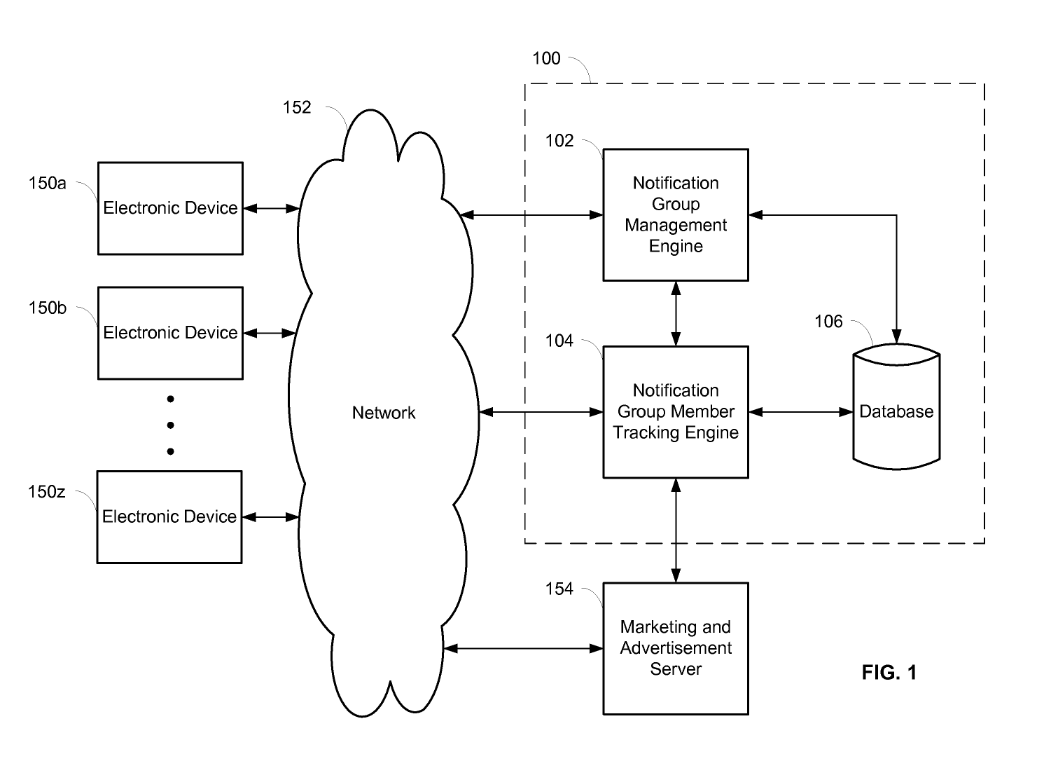

FIG. 1 illustrates a notification group tracking system 100 for creating, managing, and controlling notification groups and assigned locations, and transmitting notifications to a notification group when group members are at particular assigned locations, in accordance with one or more principles of the invention. The notification group tracking system 100 may create a notification group that associates a generic group with an assigned location, transmit invitation requests to prospective group members, and assign group members to the notification group if the group members accept the invitation requests. The notification group tracking system 100 may also generate and transmit or otherwise provide a notification to the members of a notification group by determining if a geographical location of a locatable group member corresponds to an assigned location associated with the notification group. The notification may indicate that the locatable group member is presently located at the assigned location.

By utilizing the notification group tracking system 100, a user can advantageously control both the broadcasting of the location of the user and the audience, e.g., group members of the notification group, that can see the location of the user. A notification group, such as an affinity group, may include group members that have common interests, backgrounds, etc., such as fans of a sports team, alumni of a college or university, a group of friends, family members, and/or colleagues. A notification group may be associated with an assigned location, such as an associated social hub, that is a particular geographical location. For example, the assigned location may be a stadium, arena, home, work, library, public meeting place, or other geographical location that is related to the notification group. By way of further example, a notification group in the form of an affinity group may be a group of fans of a particular sports team and that affinity group may have one or more assigned locations in the form of associated social hubs based on the group's activities in connection with that group and its common interests. In such an example, the affinity group may have an associated social hub at a particular pub or restaurant to watch the particular sports team's games.

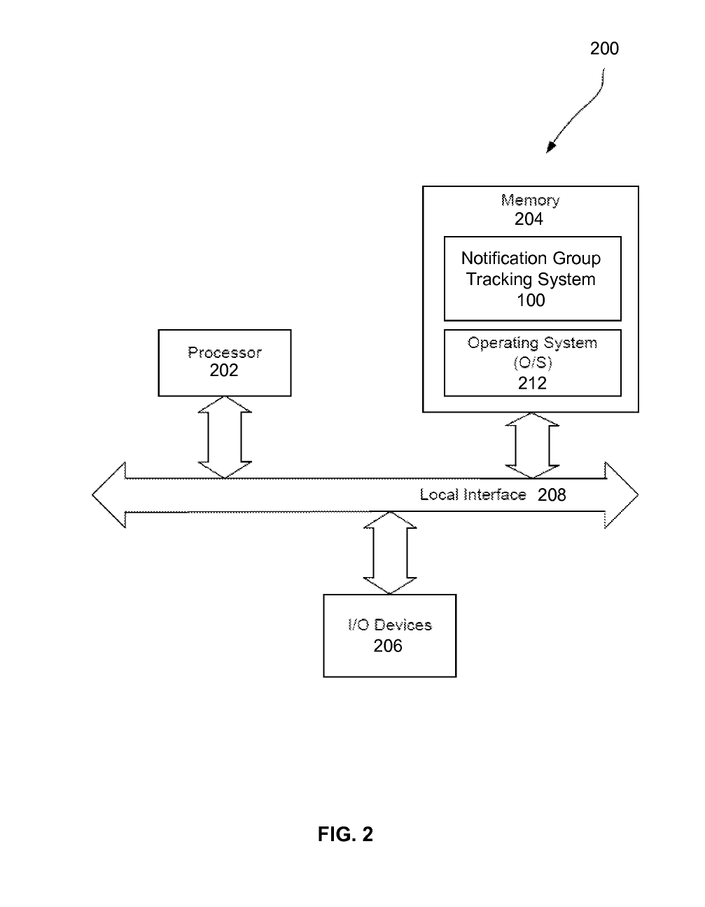

Various components of the notification group tracking system 100 may be implemented using software executable by one or more servers or computers, such as a computing device 200 with a processor 202 and memory 204 as shown in FIG. 2, which is described in more detail below.

One or more electronic devices 150a, 150b, . . . , 150z may communicate with the notification group tracking system 100 through a data network 152, such as the Internet. In particular, the electronic devices 150a, 150b, . . . , 150z may communicate with a notification group management engine 102 and a notification group member tracking engine 104 in the notification group tracking system 100. The electronic devices 150a, 150b, . . . , 150z may also communicate with a marketing and advertisement server 154 through the data network 152. Each of the electronic devices 150a, 150b, . . . , 150z may be, for example, a smartphone, a cellular phone, a personal digital assistant, a tablet computer, a laptop computer, or the like. In one embodiment, an application executing on the electronic devices 150a, 150b, . . . , 150z facilitates communication with the notification group tracking system 100 and/or the marketing and advertisement server 154. The application may include a web browser, a specific application for communicating with the notification group tracking system 100, or another type of application. An electronic device 150a, 150b, . . . , 150z may also be referred to as an electronic device 150 in this specification.

A group creation request can be received from an electronic device 150 by the notification group management engine 102. The group creation request may include a request to create a generic group that is associated with a user, such as the user of the electronic device 150. The user can be considered the owner of the generic group. The group creation request can include one or more prospective group members that the user wishes to add to a newly generated generic group. In some embodiments, the group creation request can include a request to add and/or delete a prospective group member from an existing generic group. A prospective group member can correspond to another user or person, and the prospective group member can be identified in the group creation request by name, e-mail address, phone number, username, and/or another identifier.

As an example, a user can transmit a group creation request that includes family members, friends, co-workers, and/or neighbors from a smartphone to the notification group management engine 102. The user can transmit multiple group creation requests that each creates a different generic group. In some embodiments, a single group creation request can create multiple generic groups. The prospective group members in each of the generic groups can be different, overlap, or be the same. The notification group management engine 102 can create the generic group in a database 106 based on the group creation request. The generic group includes each of the prospective group members included in the group creation request.

The notification group management engine 102 can receive a location assignment request from the electronic device 150. The location assignment request may include a request to create an assigned location that is associated with the user, such as the user of the electronic device 150. The user can be considered the owner of the assigned location for purposes of associating a generic group with the assigned location, as described below. The location assignment request can include a geographical location that the user wishes to add to the assigned location. In some embodiments, the assigned location may include multiple geographical locations. In some embodiments, the location assignment request can include a request to add and/or delete a geographical location from an existing assigned location. A geographical location can be identified in the location assignment request by an address, geographical coordinates, a business name, a stadium name, an arena name, and/or other identifier. In an embodiment, the electronic device 150 can automatically identify a user's desired geographical location by utilizing a GPS receiver or other geo-locator functionality in the electronic device 150. In this case, the geographical location derived from the geo-locator can be transmitted from the electronic device 150 as part of the location assignment request.

For example, the user can transmit a location assignment request from a tablet computer to the notification group management engine 102 that includes the address of the user's home. The user can transmit multiple location assignment requests that each creates a different assigned location. In some embodiments, a single location assignment request can create multiple assigned locations. The geographical locations in each of the assigned locations can be different, overlap, or be the same. The notification group management engine 102 can create the assigned location in a database 106 based on the location assignment request. The assigned location includes the geographical location included in the location assignment request.

An association request can be received by the notification group management engine 102 from the electronic device 150. The association request may include a request to create a notification group that is associated with the user, such as the user of the electronic device 150. The user can be considered the owner of the notification group. The association request can include an indication of a generic group and an assigned location such that the generic group can be associated with the assigned location. The generic group and/or the assigned location may have been previously created, as described above. In some embodiments, the association request may include multiple generic groups and/or multiple assigned locations. In some embodiments, the association request can include a request to associate and/or de-associate a generic group with an assigned location. The generic group and/or the assigned location can be identified in the association request by name, identification number, and/or other identifier.

As an example, the user can transmit an association request from a smartphone to the notification group management engine 102 that includes an indication of a generic group and an assigned location that the user wishes to associate with one another. The user can transmit multiple association requests that each creates a different notification group. In some embodiments, a single associate request can create multiple notification groups. The notification groups can include generic groups and/or assigned locations that are different, overlap, or are the same. The notification group management engine 102 can create the notification group in the database 106 based on the association request. The notification group is associated with the assigned location indicated in the association request.

The notification group management engine 102 can transmit an invitation request to each of the prospective group members of the generic group that has been associated in the notification group. The invitation requests can be transmitted in response to the creation of the notification group. In particular, an invitation request can be transmitted to an electronic device 150 associated with a prospective group member. The invitation request can include the owner of the notification group, the name of the notification group, the assigned location, a list of other prospective group members, a list of group members, and/or other information. The invitation request may be specifically associated with the assigned location, and may request that the prospective group member accept or decline the invitation request. The notification group management engine 102 can transmit the invitation requests via email, SMS, social networking, mobile app alert, or other means.

A prospective group member who accepts an invitation request may transmit an acceptance of the invitation request from an electronic device 150 that is received by the notification group management engine 102. The prospective group member may accept an invitation request by clicking on a URL link or a button included in the invitation request, for example. In some embodiments, the demographics of the prospective group member may be requested, such as part of a registration process. Such a prospective group member can be considered a group member of the notification group, after an invitation request has been accepted. If a prospective group member declines and does not accept an invitation request, then that prospective group member would not be added to the notification group. In response to receiving an acceptance of an invitation request, the notification group management engine 102 can assign the accepting prospective group member as a group member of the notification group in the database 106. Each group member of a notification group can receive notifications based on the geographical location of the other group members, as described below.

The notification group member tracking engine 104 can receive a device identifier and a geographical location from an electronic device 150. The electronic device 150 can be associated with a group member of a notification group. The device identifier can uniquely identify a particular electronic device 150 that is associated with a particular group member of the notification group, and can include, for example, an International Mobile Station Equipment Identity (IMEI), an Android ID, a Media Access Control (MAC) address, a Unique Device Identifier (UDID), an IP address, an International Mobile Subscriber Identity (IMSI), and/or other unique identifier. In some embodiments, the device identifier can include a username or other identifier to uniquely identify the user of the electronic device 150 after the user has logged in or is authenticated to the notification group member tracking engine 104, for example. The geographical location received from the electronic device 150 may include an address, geographical coordinates, a business name, a stadium name, an arena name, and/or other identifier. In an embodiment, the electronic device 150 can automatically identify a user's geographical location by utilizing a GPS receiver or other geo-locator functionality in the electronic device 150. The geographical location derived from the geo-locator can then be transmitted to the notification group member tracking engine 104.

The notification group member tracking engine 104 may determine whether the geographical location received from the electronic device 150 corresponds to an assigned location associated with the notification group. The notification group, including the group members and the assigned location, may have been stored in the database 106. Accordingly, the notification group member tracking engine 104 can determine whether the current geographical location of the electronic device 150 (and therefore, the location of the associated group member) is currently present at the assigned location associated with the notification group. If the geographical location corresponds to the assigned location, then the notification group member tracking engine 104 can store in the database 106 that the group member is located at the assigned location.

The notification group member tracking engine 104 can also transmit a notification to the group members of the notification group, if the geographical location corresponds to the assigned location associated with the notification group. The notification may indicate that the particular group member is presently located at the assigned location of the notification group. The notification may include the names, phone numbers, and/or pictures of present and non-present group members, the name of the notification group, timestamps associated with the arrival and/or departure of group members, and/or other information. The notification could be transmitted, for example, as a mobile app alert, an SMS text, within an application executing on the electronic device 150, and/or on a webpage. The notification transmitted from the notification group member tracking engine 104 may result in a passive notification or an active notification to the group members. A passive notification can include, for example, reflecting that the particular group member is at an assigned location, such as by listing the particular group member on a page associated with the notification group in the application executing on the electronic device 150. An active notification can include, for example, a pop-up alert to the user on the electronic device 150.

In one embodiment, the notification group member tracking engine 104 transmits the notification to all group members of the notification group, regardless of their location. In another embodiment, the notification group member tracking engine 104 only transmits the notification to group members of the notification group who are also presently located at the assigned location. In some embodiments, a group member can customize whether notifications are received for other group members of the notification group. The customization can be received by the notification group member tracking engine 104 and stored in the database 106, or can be stored in the electronic device 150. For example, the group member may only desire to see whether family members and close friends are presently located at the assigned location.

If the geographical location does not correspond to the assigned location, then the notification group member tracking engine 104 determines whether the group member was previously located at the assigned location associated with the notification group. The presence of the group member at the assigned location may have been previously stored in the database 106, for example. If the group member had been previously located at the assigned location, then the notification group member tracking engine 104 can store in the database 106 that the group member is not presently located at the assigned location. The notification group member tracking engine 104 can also transmit a notification to the group members of the notification group, if the group member had been previously located at the assigned location. This notification may indicate that the particular group member is not presently located at the assigned location of the notification group. However, if the group member had not been previously located at the assigned location, then the notification group member tracking engine 104 can continue to receive a device identifier and a geographical location from the electronic device 150.

The notification group member tracking engine 104 can also determine whether a trigger event has occurred. A trigger event may be a particular time and/or location that causes information to be transmitted to the electronic device 150 in response to the trigger event. A threshold time and/or a particular location may be set in the database 106 by an advertiser or other entity utilizing the marketing and advertisement server 154 that is in communication with the notification group member tracking engine 104. As an example, the threshold time may be set to the seventh inning of a baseball game when group members attending the baseball game may be considering what they want to do after the game is over. As another example, a threshold location may include the exit gates of a stadium. When the trigger event occurs, e.g., when the seventh inning is reached or the user is at the exit gates of the stadium, then the notification group member tracking engine 104 may transmit information to the electronic device 150. In some embodiments, the notification group member tracking engine 104 may direct the marketing and advertisement server 154 to transmit information to the electronic device 150. The information may include, for example, specials at local establishments, coupons, information regarding public transportation and taxicabs, safety information, and/or other information. However, if the trigger event has not occurred, then the notification group member tracking engine 104 can continue to receive a device identifier and a geographical location from the electronic device 150.

As an example of the use of the notification group tracking system 100, a user may access a mobile application executing on the user's electronic device 150. The user may wish to create a notification group, such as an affinity group, that associates a generic group and an assigned location, such as an associated social hub. The user may utilize the mobile application to create and transmit a group creation request to the notification group management engine 102 to create a generic group (e.g., “Bob's Friends”), such as the user's friends who are fans of the same sports team. The generic group may be owned by the user, and can include prospective group members. The user may select existing users to add as prospective group members or may enter the email addresses of the prospective group members, for example. The notification group management engine 102 can create the generic group in the database 106 in response to the group creation request. At this point, the generic group (and its prospective group members) is not associated with any particular assigned location. The user may also utilize the mobile application to create and transmit a location assignment request to the notification group management engine 102 to create an assigned location, such as the stadium where the sports team plays its home games, e.g., Wrigley Field. The assigned location may be owned by the user, and can include a particular geographical location. For example, the user may enter a particular address or landmark as the assigned location. The notification group management engine 102 can create the assigned location in the database 106 in response to the location assignment request.

After creating a generic group and an assigned location, the user may utilize the mobile application to transmit an association request to the notification group management engine 102. The association request may be a request to create the notification group that associates the generic group and the assigned location to one another. For example, the user can specify a particular generic group (e.g., “Bob's Friends”) that the user wishes to associate with a particular assigned location (e.g., Wrigley Field) to create the notification group (e.g., “Bob's Cubs Fans”). The notification group management engine 102 can create the notification group in the database 106 in response to the association request. Therefore, in this example, the notification group includes the user's friends who are fans of the same sports team associated with the stadium of the sports team. After creating the notification group, the notification group management engine 102 can transmit an invitation request to each of the prospective group members of the generic group in the notification group. The invitation requests can be transmitted to ask whether the prospective group member wishes to join the notification group for the assigned location. If the prospective group member accepts the invitation request, then the acceptance may be received by the notification group management engine 102, which will assign that prospective group member as a group member of the notification group in the database 106. Group members of the notification group will receive notifications when some or all of the members of the notification group are at the assigned location.

Group members may be utilizing electronic devices 150 and may be present at the assigned location of the notification group. The electronic device 150 can transmit device identifiers and current geographical locations to inform the notification group member tracking engine 104 of the locations of the group members. A particular group member transmits that their current geographical location is the assigned location, e.g., the stadium of the sports team, associated with the notification group. The notification group member tracking engine 104, in response, transmits a passive notification to the group members of the notification group. For example, the particular group member can be listed on a page in the mobile application to indicate to the group members that the particular group member is at the stadium. The passive notification can be, for example, a message to the mobile application to list the particular group member on the page associated with the notification group. If the particular group member transmits that their current geographical location is somewhere other than the stadium, then the notification group member tracking engine 104 can transmit a message to the mobile application to indicate that the particular group member is not at the stadium on the page.

FIG. 2 is a block diagram of a computing device 200 housing executable software used to facilitate the notification group tracking system 100. One or more instances of the computing device 200 may be utilized to implement any, some, or all of the components in the notification group tracking system 100, including the notification group management engine 102 and the notification group member tracking engine 104. Computing device 200 includes a memory element 204. Memory element 204 may include a computer readable medium for implementing the notification group tracking system 100, and for implementing particular system transactions. Memory element 204 may also be utilized to implement the database 106. Computing device 200 also contains executable software, some of which may or may not be unique to the notification group tracking system 100.

In some embodiments, the notification group tracking system 100 is implemented in software, as an executable program, and is executed by one or more special or general purpose digital computer(s), such as a mainframe computer, a personal computer (desktop, laptop or otherwise), personal digital assistant, or other handheld computing device. Therefore, computing device 200 may be representative of any computer in which the notification group tracking system 100 resides or partially resides.

Generally, in terms of hardware architecture as shown in FIG. 2, computing device 200 includes a processor 202, a memory 204, and one or more input and/or output (I/O) devices 206 (or peripherals) that are communicatively coupled via a local interface 208. Local interface 208 may be one or more buses or other wired or wireless connections, as is known in the art. Local interface 208 may have additional elements, which are omitted for simplicity, such as controllers, buffers (caches), drivers, transmitters, and receivers to facilitate external communications with other like or dissimilar computing devices. Further, local interface 208 may include address, control, and/or data connections to enable internal communications among the other computer components.

Processor 202 is a hardware device for executing software, particularly software stored in memory 204. Processor 202 can be any custom made or commercially available processor, such as, for example, a Core series or vPro processor made by Intel Corporation, or a Phenom, Athlon or Sempron processor made by Advanced Micro Devices, Inc. In the case where computing device 200 is a server, the processor may be, for example, a Xeon or Itanium processor from Intel, or an Opteron-series processor from Advanced Micro Devices, Inc. Processor 202 may also represent multiple parallel or distributed processors working in unison.

Memory 204 can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It may incorporate electronic, magnetic, optical, and/or other types of storage media. Memory 204 can have a distributed architecture where various components are situated remote from one another, but are still accessed by processor 202. These other components may reside on devices located elsewhere on a network or in a cloud arrangement.

The software in memory 204 may include one or more separate programs. The separate programs comprise ordered listings of executable instructions for implementing logical functions. In the example of FIG. 2, the software in memory 204 may include the notification group tracking system 100 in accordance with the invention, and a suitable operating system (O/S) 212. Examples of suitable commercially available operating systems 212 are Windows operating systems available from Microsoft Corporation, Mac OS X available from Apple Computer, Inc., a Unix operating system from AT&T, or a Unix-derivative such as BSD or Linux. The operating system O/S 212 will depend on the type of computing device 200. For example, if the computing device 200 is a PDA or handheld computer, the operating system 212 may be iOS for operating certain devices from Apple Computer, Inc., PalmOS for devices from Palm Computing, Inc., Windows Phone 8 from Microsoft Corporation, Android from Google, Inc., or Symbian from Nokia Corporation. Operating system 212 essentially controls the execution of other computer programs, such as the notification group tracking system 100, and provides scheduling, input-output control, file and data management, memory management, and communication control and related services.

If computing device 200 is an IBM PC compatible computer or the like, the software in memory 204 may further include a basic input output system (BIOS). The BIOS is a set of essential software routines that initialize and test hardware at startup, start operating system 212, and support the transfer of data among the hardware devices. The BIOS is stored in ROM so that the BIOS can be executed when computing device 200 is activated.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ruby, Ada, and Lua. Components of the notification group tracking system 100 may also be written in a proprietary language developed to interact with these known languages.

I/O device 206 may include input devices such as a keyboard, a mouse, a scanner, a microphone, a touch screen, a bar code reader, or an infra-red reader. It may also include output devices such as a printer, a video display, an audio speaker or headphone port or a projector. I/O device 206 may also comprise devices that communicate with inputs or outputs, such as a short-range transceiver (RFID, Bluetooth, etc.), a telephonic interface, a cellular communication port, a router, or other types of network communication equipment. I/O device 206 may be internal to computing device 200, or may be external and connected wirelessly or via connection cable, such as through a universal serial bus port.

When computing device 200 is in operation, processor 202 is configured to execute software stored within memory 204, to communicate data to and from memory 204, and to generally control operations of computing device 200 pursuant to the software. The notification group tracking system 100 and operating system 212, in whole or in part, may be read by processor 202, buffered within processor 202, and then executed.

In the context of this document, a “computer-readable medium” may be any means that can store, communicate, propagate, or transport data objects for use by or in connection with the notification group tracking system 100. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The notification group tracking system 100 can be embodied in any type of computer-readable medium for use by or in connection with an instruction execution system or apparatus, such as a computer.

For purposes of connecting to other computing devices, computing device 200 is equipped with network communication equipment and circuitry. In an embodiment, the network communication equipment includes a network card such as an Ethernet card, or a wireless connection card. In a network environment, each of the plurality of computing devices 200 on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while an embodiment of the invention is for each computing device 200 to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks.

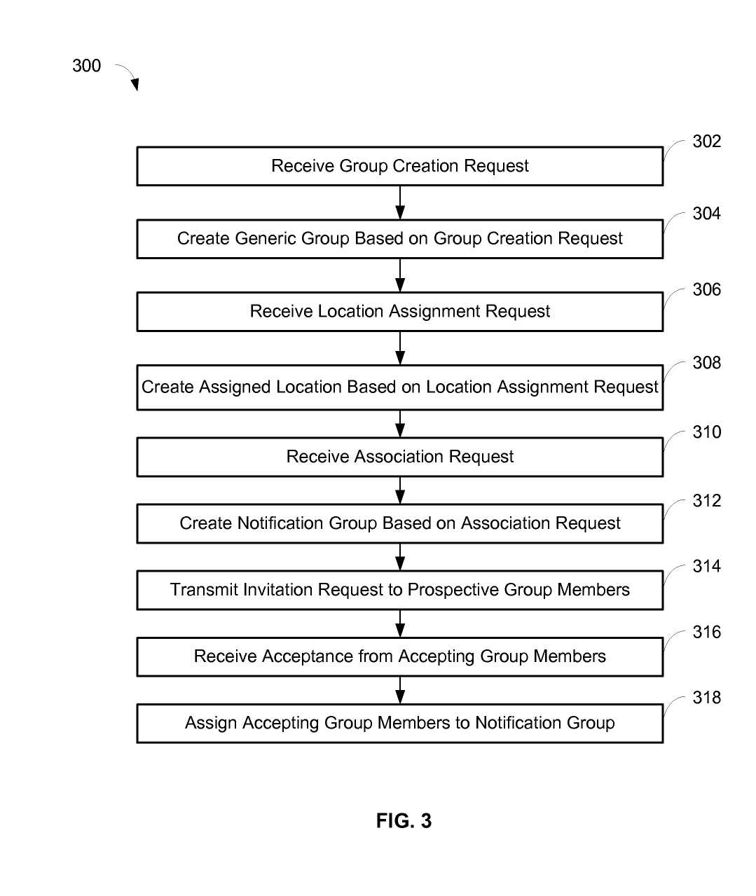

An embodiment of a process 300 for creating a location-based notification group is shown in FIG. 3, in accordance with one or more principles of the invention. The process 300 may result in the creation of a notification group or affinity group including one or more group members. The notification group can be association of a generic group and an assigned location, such as an associated social hub. The group members of the notification group can receive notifications as to the presence of other group members at the assigned location. The notification group management engine 102 may perform all or part of the process 300. The process 300 can utilize the database 106.

At step 302, a group creation request can be received from an electronic device 150. The group creation request may include a request to create a generic group that is associated with a user, such as the user of an electronic device 150. The group creation request can include one or more prospective group members that the user wishes to add to a newly generated generic group. In some embodiments, the group creation request can include a request to add and/or delete a prospective group member from an existing generic group. A prospective group member can correspond to another user or person, and the prospective group member can be identified in the group creation request by name, e-mail address, phone number, username, and/or another identifier. The generic group can be created at step 304, based on the group creation request. The generic group includes each of the prospective group members included in the group creation request.

A location assignment request can be received at step 306 from the electronic device 150. The location assignment request may include a request to create an assigned location that is associated with the user, such as the user of the electronic device 150. The location assignment request can include a geographical location that the user wishes to add to the assigned location. In some embodiments, the assigned location may include multiple geographical locations. In some embodiments, the location assignment request can include a request to add and/or delete a geographical location from an existing assigned location. A geographical location can be identified in the location assignment request by an address, geographical coordinates, a business name, a stadium name, an arena name, and/or other identifier. In an embodiment, the electronic device 150 can automatically identify a user's desired geographical location by utilizing a GPS receiver or other geo-locator functionality in the electronic device 150. The assigned location can be created at step 308, based on the location assignment request. The assigned location includes the geographical location included in the location assignment request.

At step 310, an association request can be received from the electronic device 150. The association request may include a request to create a notification group that is associated with the user, such as the user of the electronic device 150. The association request can include an indication of a generic group and an assigned location such that the generic group can be associated with the assigned location. The generic group and/or the assigned location may have been previously created, as described above. In some embodiments, the association request may include multiple generic groups and/or multiple assigned locations. In some embodiments, the association request can include a request to associate and/or de-associate a generic group with an assigned location. The generic group and/or the assigned location can be identified in the association request by name, identification number, and/or other identifier. The notification group can be created at step 312, based on the association request.

Invitation requests can be transmitted to each of the prospective group members of the generic group that has been associated in the notification group, at step 314. In particular, an invitation request can be transmitted to an electronic device 150 associated with a prospective group member. The invitation request can include the owner of the notification group, the name of the notification group, the assigned location, a list of other prospective group members, a list of group members, and/or other information. The notification group management engine 102 can transmit the invitation requests via email, SMS, social networking, mobile app alert, or other means.

An acceptance of an invitation request can be received from an electronic device 150 at step 316. The prospective group member may accept an invitation request by clicking on a URL link or a button, for example. Such a prospective group member can be considered a group member of the notification group, after an invitation request has been accepted. In response to receiving an acceptance of an invitation request, the accepting prospective group member can be assigned as a group member of the notification group, at step 318. Each group member of a notification group can receive notifications based on the geographical location of the other group members, as described below.

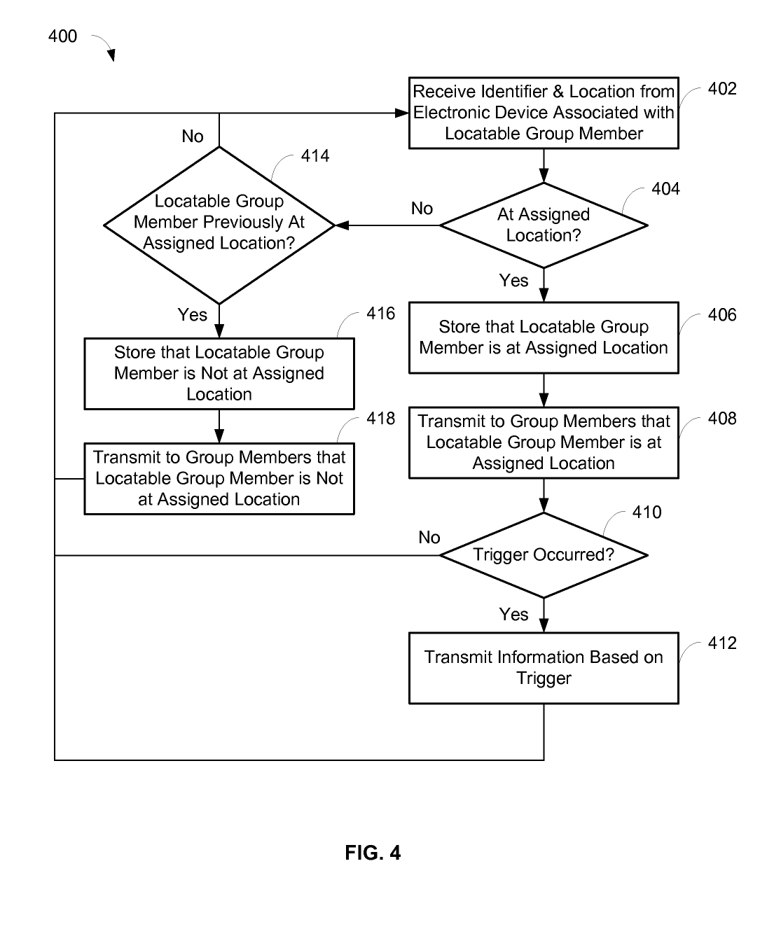

An embodiment of a process 400 for generating a notification to a location-based notification group is shown in FIG. 4, in accordance with one or more principles of the invention. The process 400 may result in transmitting notifications regarding the locations of group members of a notification group to the group members, particularly when the group members are at the assigned location associated with the notification group. The process 400 may also result in transmitting information to the group members in response to the occurrence of an event trigger. The notification group member tracking engine 104 may perform all or part of the process 400. The process 400 can also utilize the database 106.

At step 402, a device identifier and a geographical location can be received from an electronic device 150. The electronic device 150 can be associated with a group member of a notification group. The device identifier can uniquely identify a particular electronic device 150 that is associated with a particular group member of the notification group, and can include, for example, an International Mobile Station Equipment Identity (IMEI), an Android ID, a Media Access Control (MAC) address, a Unique Device Identifier (UDID), an IP address, an International Mobile Subscriber Identity (IMSI), and/or other unique identifier. In some embodiments, the device identifier can include a username or other identifier to uniquely identify the user of the electronic device 150 after the user has logged in or is authenticated, for example. The geographical location received from the electronic device 150 may include an address, geographical coordinates, a business name, a stadium name, an arena name, and/or other identifier. In an embodiment, the electronic device 150 can automatically identify a user's geographical location by utilizing a GPS receiver or other geo-locator functionality in the electronic device 150 and transmitting the geographical location to be received at step 402.

It can be determined at step 404 whether the received geographical location corresponds to an assigned location associated with the notification group. In other words, it can be determined whether the current geographical location of the electronic device 150 (and therefore, the location of the associated group member) is currently present at the assigned location associated with the notification group. If the geographical location corresponds to the assigned location at step 404, then it can be stored at step 406 that the group member is located at the assigned location associated with the notification group. A notification can also be transmitted to the group members of the notification group at step 408, if the geographical location corresponds to the assigned location associated with the notification group. The notification may indicate that the particular group member is presently located at the assigned location associated with the notification group. The notification may include the names, phone numbers, and/or pictures of present and non-present group members, the name of the notification group, timestamps associated with the arrival and/or departure of group members, and/or other information. The notification transmitted from the notification group member tracking engine 104 may result in a passive notification or an active notification to the group members. The notification could be transmitted, for example, as a mobile app alert or an SMS text, or may result in the reflection that the group member is present at an assigned location, such as by listing the group member on a page in an application executing on an electronic device. In one embodiment, the notification group member tracking engine 104 transmits the notification to all group members, regardless of their location. In another embodiment, the notification group member tracking engine 104 transmits the notification to group members who are also presently located at the assigned location.

At step 410, it can be determined whether a trigger event has occurred. A trigger event may be a particular time and/or location that causes information to be transmitted to an electronic device 150 in response to the trigger event. A threshold time and/or a particular location may be set in the database 106 by an advertiser or other entity. When the trigger event occurs, information may be transmitted to the electronic device 150 at step 412. The information may include, for example, specials at local establishments, coupons, information regarding public transportation and taxicabs, safety information, and/or other information. However, if the trigger event has not occurred at step 410, then the process 400 returns to step 402 to receive a device identifier and a geographical location from the electronic device 150.

However, if the geographical location does not correspond to the assigned location at step 404, then the process 400 continues to step 414. At step 414, it can be determined whether the group member was previously located at the assigned location associated with the notification group. The presence of the group member at the assigned location may have been previously stored in the database 106, for example. If the group member had been previously located at the assigned location at step 414, then it can be stored at step 416 that the group member is not presently located at the assigned location associated with the notification group. At step 418, a notification can also be transmitted to the group members of the notification group, if the group member had been previously located at the assigned location. This notification may indicate that the particular group member is not presently located at the assigned location of the notification group. If the group member had not been previously located at the assigned location at step 414, then the process 400 returns to step 402 to receive a device identifier and a geographical location from the electronic device 150.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

It should be emphasized that the above-described embodiments of the invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the invention and protected by the following claims.

1. A method of creating a location-based notification group using a processor, the method comprising:
receiving a group creation request at the processor, the group creation request comprising a request to create a generic group including one or more prospective group members;
creating the generic group in a database based on the group creation request, using the processor, the generic group comprising the one or more prospective group members;
receiving a location assignment request at the processor, the location assignment request comprising a request to create an assigned location including a geographical location;
creating the assigned location in the database based on the location assignment request, using the processor, the assigned location comprising the geographical location;
receiving an association request at the processor, the association request comprising a request to create the notification group associating the generic group with the assigned location;
creating the notification group in the database, using the processor, based on the association request;
transmitting an invitation request from the processor to each of the one or more prospective group members of the generic group, in response to creating the notification group;
receiving an acceptance of the invitation request at the processor from at least one group member of the one or more prospective group members; and
assigning the at least one group member to the notification group in the database, in response to receiving the acceptance of the invitation request, using the processor.

2. The method of claim 1, wherein the geographical location comprises one or more of a business, a stadium, an arena, an address, or geographical coordinates.

3. The method of claim 1, wherein the assigned location further comprises one or more portions of the geographical location.

4. The method of claim 1, wherein the group creation request, the location assignment request, and the association request are associated with an owner of the notification group.

5. The method of claim 1, wherein the notification group comprises a plurality of notification groups, and the assigned location comprises a plurality of assigned locations.

6. A method of generating a notification to a location-based notification group, the notification group comprising one or more group members, using a processor, the method comprising:
receiving a device identifier and a geographical location at the processor, the device identifier for uniquely identifying an electronic device associated with a locatable group member of the one or more group members;
determining if the geographical location corresponds to an assigned location associated with the notification group in a database, using the processor; and
if the geographical location corresponds to the assigned location:
storing in the database that the locatable group member is located at the assigned location, using the processor; and
transmitting the notification from the processor to each of the one or more group members, the notification indicating that the locatable group member is presently located at the assigned location.

7. The method of claim 6, further comprising:
determining if a trigger event has occurred, using the processor, the trigger event comprising one or more of a time trigger or a location trigger; and
transmitting information from the processor to at least one of the one or more group members, using the processor, if the trigger event has occurred.

8. The method of claim 7, wherein receiving comprises receiving the device identifier and the geographical location at the processor, if the trigger event has not occurred.

9. The method of claim 6, further comprising:
if the geographical location does not correspond to the assigned location:
determining if the locatable group member was previously located at the assigned location, using the processor; and
if the locatable group member was previously located at the assigned location:
storing in the database that the locatable group member is not located at the assigned location, using the processor; and
transmitting the notification from the processor to each of the one or more group members, the notification indicating that the locatable group member is not presently located at the assigned location.

10. The method of claim 9, wherein receiving comprises receiving the device identifier and the geographical location at the processor, if the locatable group member was not previously located at the assigned location.

11. The method of claim 6, wherein storing comprises storing a timestamp in the database of when the locatable group member is located at the assigned location, if the geographical location corresponds to the assigned location.

12. The method of claim 6, wherein the electronic device comprises one or more of a smartphone, a personal digital assistant, a tablet computer, a cellular phone, a laptop computer, or a desktop computer.

13. A system for creating a location-based notification group, the system comprising:
a processor in communication with a network; and
a memory in communication with the processor, the memory for storing:
a database;
a notification group management engine for:
receiving a group creation request, the group creation request comprising a request to create a generic group including one or more prospective group members;
creating the generic group in the database based on the group creation request, the generic group comprising the one or more prospective group members;
receiving a location assignment request, the location assignment request comprising a request to create an assigned location including a geographical location;
creating the assigned location in the database based on the location assignment request, the assigned location comprising the geographical location;
receiving an association request, the association request comprising a request to create the notification group associating the generic group with the assigned location;
creating the notification group in the database, based on the association request;
transmitting an invitation request to each of the one or more prospective group members of the generic group, in response to creating the notification group;
receiving an acceptance of the invitation request from at least one group member of the one or more prospective group members; and
assigning the at least one group member to the notification group in the database, in response to receiving the acceptance of the invitation request.

14. The system of claim 13, wherein the group creation request, the location assignment request, and the association request are associated with an owner of the notification group.

15. The system of claim 13, wherein the notification group comprises a plurality of notification groups, and the assigned location comprises a plurality of assigned locations.

16. The system of claim 13, wherein the memory is further for storing a notification group member tracking engine for:
receiving a device identifier and the geographical location, the device identifier for uniquely identifying an electronic device associated with a locatable group member of one or more group members that comprise the location-based notification group;
determining if the geographical location corresponds to the assigned location associated with the notification group in the database; and
if the geographical location corresponds to the assigned location:
storing in the database that the locatable group member is located at the assigned location; and
transmitting a notification to each of the one or more group members, the notification indicating that the locatable group member is presently located at the assigned location.

17. The system of claim 16, wherein the notification group member tracking engine is further for:
determining if a trigger event has occurred, the trigger event comprising one or more of a time trigger or a location trigger; and
transmitting information to at least one of the one or more group members, using the processor, if the trigger event has occurred.

18. The system of claim 16, wherein the notification group member tracking engine is further for:
if the geographical location does not correspond to the assigned location:
determining if the locatable group member was previously located at the assigned location; and
if the locatable group member was previously located at the assigned location:
storing in the database that the locatable group member is not located at the assigned location; and
transmitting the notification to each of the one or more group members, the notification indicating that the locatable group member is not presently located at the assigned location.

19. The system of claim 16, wherein the notification group member tracking engine for storing comprises the notification group member tracking engine for storing a timestamp in the database of when the locatable group member is located at the assigned location, if the geographical location corresponds to the assigned location.

20. The system of claim 16, wherein the electronic device comprises one or more of a smartphone, a personal digital assistant, a tablet computer, a cellular phone, a laptop computer, or a desktop computer.
